(19) United States
(12) Patent Application Publication
(10) Pub. No.: US 2002/0065122 A1
(43) Pub. Date: May 30, 2002

(54) Module for playing a game

(76) Inventors: Thomas White, Ipswich (GB); Giannetto Mariani, Ipswich (GB); Adrian Woolfe, London (GB)

Correspondence Address: D. PETER HOCHBERG CO. L.P.A., 1940 EAST 6TH STREET, CLEVELAND, OH, 44114, US

(21) Appl. No.: 10/058,563

(22) Filed: Jan. 28, 2002

Related U.S. Application Data
(63) Continuation of application No. 09/493,875, filed on Jan. 28, 2000.

(30) Foreign Application Priority Data
Jan. 29, 1999 (GB) 9901954.9

(51) Int. Cl. A63F 13/00

(52) U.S. Cl. 463/9

(57) ABSTRACT

A hand-held module (10) for use in a game has a slot or socket (12) into which a printed question and answer card (14) can be inserted. The module has a first window (18) in one face of the module for allowing viewing of a first area (where a question is printed) of a card in the slot and second windows (20) in the same face of the module for allowing viewing of second areas (where alternative possible answers are printed) of the card. The second windows (20) have means such as a sliding shutter (25) which the user can use to mark selected ones of the second windows (to indicate which possible answer the user believes is correct).

This invention relates to a hand-held module for playing a game in which questions are asked from pre-printed cards.

According to the invention, there is provided a hand-held module for use in a game, the module comprising a slot for receiving a printed card, a first window in one face of the module for giving visual access to a first area of a card in the slot, a plurality of second windows in the same face of the module for giving visual access to second areas of the card, and means for marking selected ones of the second windows.

When a card is inserted in the module, a question printed on the card can be viewed through the first window, and ‘multiple-choice’ answers can be viewed through the second windows. The second windows can then be marked by the players answering the questions. Either all wrong answers can be marked, or the single correct answer can be marked.

If the card has the correct answer marked on the reverse face of the card, the module may also have a window on the back of the module, opposite the face in which the first and second windows lie.

The module may have pre-printed messages/graphics printed on the internal surfaces of the module which will be visible through the windows when no card is inserted.

The means for marking the second windows can take a variety of forms. For example each window may be provided with a shutter which can be slid across the window to close the window. Alternatively each window could have a movable flag which could display either a tick or a cross.

Still further, each window could be provided with a surface which can be written on and wiped clean, so that the player can use a writing implement to mark the selected second windows. Yet another alternative would be to have a small electronic circuit with LED or similar indicators which can be selectively illuminated alongside each window. Many other alternative ways of marking the second windows can be devised. It is however important that the marking should be removable/cancellable when the question on one card has been answered and before the question on the next card is presented to the players.

The slot should allow a card to be inserted by sliding it in from one edge. One face of the module can have a cutaway edge region to allow the card to be gripped while it is in the slot, so that it can be removed and replaced.

The module can be used in connection with a game which is played as follows:

The game apparatus consists of a module for each player (any number of players; four would be a typical number) and a set of pre-printed question cards. Optionally, the apparatus could include a timing device and a way of recording each player's score. This recording could be accomplished using a playing board with the players moving pieces around the board in accordance with their success in answering questions. Alternatively, the players could receive ‘play’ money for answering questions, with the size of the monetary rewards increasing with the number of correct sequential answers.

In particular, the game could follow the format of the TV game show ‘Who Wants To Be a Millionaire?’.

One player starts as the question master. He takes the first question card and inserts it in his module. He then shows the module to the remaining players who can view the question through the first window and four possible answers through the second window. The remaining players have modules but with no card inserted. These players then mark the second windows of their modules according to their decision as to which of the possible answers is the correct one. When all players have marked their modules, they all show their modules to the question master who tells them whether their answers are right or wrong, and allocates points/money accordingly.

The game them moves on by removing the first question card from the question master's module and inserting the next card.

The rules may provide that one person remains as question master throughout each game, or that the role of question master rotates amongst the players.

The invention will now be further described, by way if example, with reference to the accompanying drawings, in which:

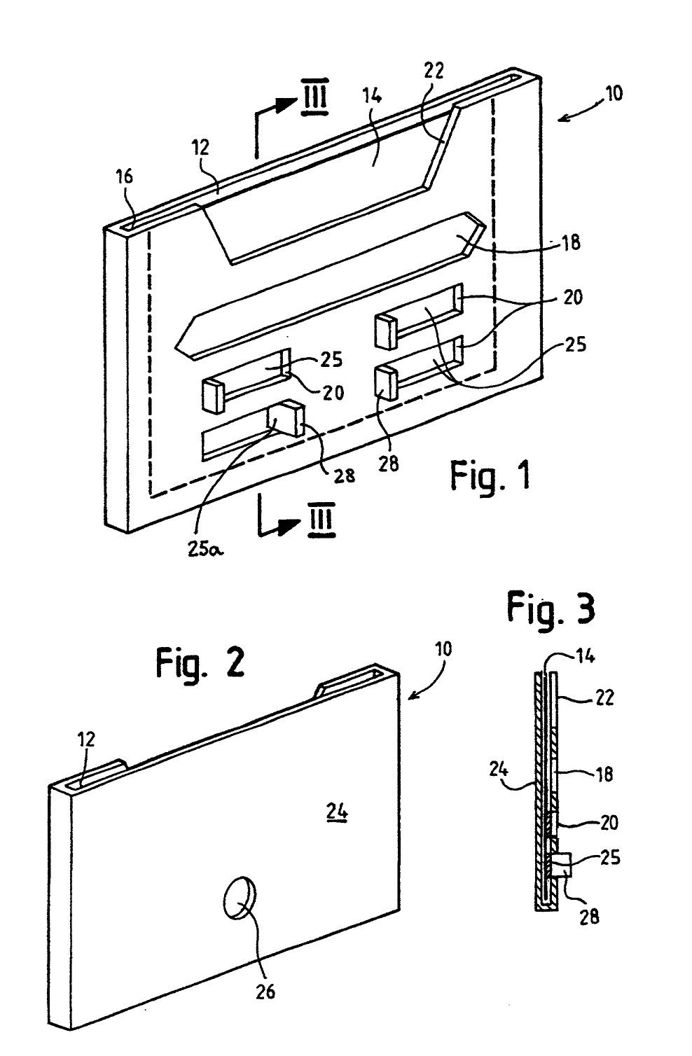

FIG. 1 is a perspective view of a module in accordance with the invention, from the front and one side;

FIG. 2 is a perspective view of the module of FIG. 1, from the back and the other side;

FIG. 3 is a cross-section through the module, on the line III-III from FIG. 1; and

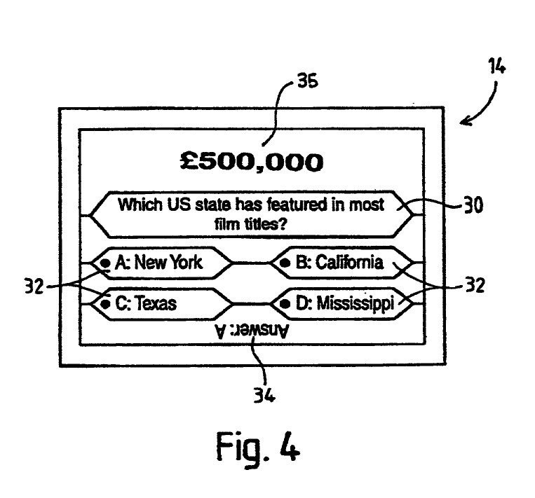

FIG. 4 shows the layout of printed information on a card for use with the module of FIGS. 1 to 3.

The module 10 shown in FIG. 1 is generally rectangular in form, is designed to be held in the hand and can have overall dimensions of approximately 75 mm×125 mm×5 mm. The module has a slot 12 into which a question card 14 (FIG. 4) can be inserted through the slot opening 16.

Games which use sets of pre-printed question cards are known. The cards are generally of a consistent size; about 60-70 mm×90-100 mm. The cards 14 for this game will follow a similar size format.

The overall size of the module should be such that it can hold a question card and that a player can hold it in his/her hand in such a way that the other players cannot see the front face of the module whilst that player is selecting an answer to a question and marking the module accordingly.

The module has a first window 18 and four second windows 20. The first window is larger than each of the second windows. At the top edge, the module also has a cut-out 22 which allows a card inserted in the module to be gripped and removed, and which also displays information printed on the card, for example the monetary value of the question being asked.

On the back face 24 of the module, there is an aperture 26 which allows a portion of the back face of a card to be viewed.

Each of the second windows 20 is fitted with a slidable shutter 25 which can be slid in one direction to open the window and in the opposite direction to close the window. The shutters 25 have a tab 28 which allows them to be gripped and moved.

In FIG. 1, one of the shutters (25a) is shown open and the other three shutters are shown closed.

Each card 14 has a printed question in an area 30 and four ‘multiple-choice’ answers in areas 32. The reverse side of the card can be laid out in the same way, with a different question and different answers. In a further area 34, the correct answer to a question on the other side of the card is printed. In an area 35, a monetary vlaue associated with the question is printed.

When the card is inserted in the module, the areas 30, 32 and 35 will be visible through the windows 18, 20 and 22. The answer to the question visible through window 20 will be visible through the window 26 on the back of the module.

As explained above, when a game is being played, each player will have a module, but only one player's (the question master's) module will have a card inserted. The other players will mark the windows 20 of their modules to indicate which of the four possible answers they think is correct, by closing the shutters 25 on all the windows except the one which corresponds in position to the window of the question masters' module which that player thinks the correct answer is visible. To aid this, the answers may be identified on the card with, for example, a letter A, B, C, D (FIG. 4) and the module may have these letters permanently marked against the windows 22.

Although the module shown has four second windows 22, there could be more or less than this number, depending on how many possible answers are to be displayed.

The module described will enable a group of players to play amongst themselves a game very similar to the TV game show ‘Who Wants To Be a Millionaire’.

1. A hand-held module for use in a game, the module comprising a slot for receiving a printed card, a first window in one face of the module for giving visual access to a first area of a card in the slot, a plurality of second windows in the same face of the module for giving visual access to second areas of the card, and means for marking selected ones of the second windows.

2. A module as claimed in claim 1, for use with a printed card which has a question printed on the card arranged to be viewed through the first window, and ‘multiple-choice’ answers arranged to be viewed through the second windows.

3. A module as claimed in claim 1 which has a window on the back of the module, opposite the face in which the first and second windows lie.

4. A module as claimed in claim 1, wherein pre-printed messages/graphics are printed on the internal surfaces of the module which will be visible through the windows when no card is inserted.

5. A module as claimed in claim 1, wherein the means for marking the second windows comprises a shutter which can be slid across the window to close the window.

6. A module as claimed in claim 1, wherein the means for marking the second windows comprises a movable flag which could display either a tick or a cross.

7. A module as claimed in claim 1, wherein the means for marking the second windows comprises a surface which can be written on and wiped clean.

8. A module as claimed in claim 1, wherein the means for marking the second windows comprises an electronic circuit with LED or similar indicators which can be selectively illuminated alongside each window.

9. A module as claimed in claim 1, wherein the slot allows a card to be inserted by sliding it in from one edge.

10. A module as claimed in claim 1, wherein one face of the module has a cut-away edge region to allow the card to be gripped while it is in the slot, so that it can be removed and replaced.

11. Apparatus for playing a game, the apparatus comprising a hand-held module as claimed in any preceding claim for each player and a set of pre-printed question cards, wherein the game is played in accordance with the following scheme:
one player starts as the question master. He takes the first question card and inserts it in his module. He then shows the module to the remaining players who can view the question through the first window and four possible answers through the second window.
the remaining players have modules but with no card inserted.
these players then mark the second windows of their modules according to their decision as to which of the possible answers is the correct one.
when all players have marked their modules, they all show their modules to the question master who tells them whether their answers are right or wrong, and allocates points/money accordingly.
the game them moves on by removing the first question card from the question master's module and inserting the next card.

12. Apparatus as claimed in claim 11, wherein the scheme provides that one person remains as question master throughout each game, or that the role of question master rotates amongst the players.
